(19) United States
(12) Patent Application Publication
(10) Pub. No.: US 2026/0319724 A1
(43) Pub. Date: Oct. 15, 2026

(54) DISPLAY SWITCHING METHOD, ELECTRONIC DEVICE, AND NON-TRANSITORY COMPUTER-READABLE STORAGE MEDIUM

(71) Applicant: GUANGDONG OPPO MOBILE TELECOMMUNICATIONS CORP., LTD., Dongguan (CN)

(72) Inventor: Hua TAO, Dongguan (CN)

(73) Assignee: GUANGDONG OPPO MOBILE TELECOMMUNICATIONS CORP., LTD., Dongguan (CN)

(21) Appl. No.: 19/342,181

(22) Filed: Sep. 26, 2025

Related U.S. Application Data
(63) Continuation of application No. PCT/CN2024/084666, filed on Mar. 29, 2024.

(30) Foreign Application Priority Data
Mar. 29, 2023 (CN) 202310324674.6

(51) Int. Cl. G06F 3/14

(52) U.S. Cl. CPC G06F 3/14

(57) ABSTRACT

A display switching method, an electronic device, and a non-transitory computer-readable storage medium. The method is performed by an electronic device which supports running of a first system and a second system, and includes: turning on a screen to display a first display interface corresponding to the first system when the first system is running, where the first display interface is a display interface of a first application corresponding to the first system; keeping the screen on to display a current frame image corresponding to the first display interface when it is determined that a screen-on display switching condition is met; generating instruction information for screen-on display switching; and based on the instruction information, switching a content displayed on the screen from the current frame image to a second display interface, where the second display interface is a display interface of a second application corresponding to the second system.

### CROSS-REFERENCE TO RELATED APPLICATIONS

The present application is a continuation-application of International (PCT) Patent Application No. PCT/CN 2024/084666, filed Mar. 29, 2024, which claims foreign priority of Chinese Patent Application No. 202310324674.6, filed on Mar. 29, 2023, both of which are incorporated herein in its entireties.

### TECHNICAL FIELD

The present disclosure relates to the field of display technologies, and in particular to a display switching method, an electronic device, and a non-transitory computer-readable storage medium.

### BACKGROUND

With the development of an electronic device, dual systems have gradually become a more reasonable configuration mode for the electronic device. For example, a smart watch supporting the dual systems may assign a scenario with complex operation logic and gorgeous interfaces to a large-core system for processing, and a scenario with relatively simple and single functions to a small-core system for processing. Two systems cooperate with each other and switch intelligently, so as to achieve a goal of long battery life of the smart watch.

### SUMMARY OF THE DISCLOSURE

According to a first aspect, some embodiments of the present disclosure may provide a display switching method, performed by an electronic device, and the electronic device may support running of a first system and a second system. The method may include: display, in a screen-on state, a first display interface corresponding to the first system in a case where the first system is running, where the first display interface is a display interface of a first application corresponding to the first system; keeping a current frame image corresponding to the first display interface displayed in the screen-on state, in a case where it is determined that a screen-on display switching condition is met; generating instruction information for screen-on display switching; and based on the instruction information, switching a content displayed in the screen-on state from the current frame image to a second display interface, where the second display interface is a display interface of a second application corresponding to the second system.

According to a second aspect, some embodiments of the present disclosure may provide an electronic device. The electronic device may include: a display module, configured to display, in a screen-on state, a first display interface corresponding to a first system in a case where the first system is running, and keep a current frame image corresponding to the first display interface displayed in the screen-on state, in a case where it is determined that a screen-on display switching condition is met, where the first display interface is a display interface of a first application corresponding to the first system; and a processing module, configured to generate instruction information for screen-on display switching; where the display module is further configured to switch a content displayed in the screen-on state from the current frame image to a second display interface based on the instruction information, and the second display interface is a display interface of a second application corresponding to a second system.

According to a third aspect, some embodiments of the present disclosure may provide a non-transitory computer-readable storage medium, and a computer program is stored in the non-transitory computer-readable storage medium. When the computer program is executed by a processor of an electronic device, the electronic device may perform the method described above.

Details of one or more embodiments of the present disclosure are set forth in the accompanying drawings and description below. Other features, and beneficial effects of the present disclosure will be embodied in the specification, the accompanying drawings, and the claims.

### BRIEF DESCRIPTION OF THE DRAWINGS

To more clearly illustrate technical solutions of embodiments in the present disclosure, the drawings required in the description of the embodiments will be briefly introduced below. Obviously, the drawings in the following description are only some embodiments of the present disclosure. For those of ordinary skills in the art, other drawings may be obtained based on these drawings without creative efforts.

FIG. 1 is a schematic diagram of an application scenario according to some embodiments of the present disclosure.

FIG. 2 is a schematic flowchart of a display switching method according to some embodiments of the present disclosure.

FIG. 3 is a schematic diagram of a system architecture of an electronic device according to some embodiments of the present disclosure.

FIG. 4 is a schematic flowchart of another display switching method according to some embodiments of the present disclosure.

FIG. 5 is a schematic diagram of a first specific example of a system architecture of an electronic device according to some embodiments of the present disclosure.

FIG. 6 is a schematic flowchart of a first specific example of a display switching method according to some embodiments of the present disclosure.

FIG. 7 is a schematic diagram of a second specific example of a system architecture of an electronic device according to some embodiments of the present disclosure.

FIG. 8 is a schematic flowchart of a second specific example of a display switching method according to some embodiments of the present disclosure.

FIG. 9 is a schematic block diagram of an electronic device according to some embodiments of the present disclosure.

### DETAILED DESCRIPTION

### Explanations of Terms

1. Dual systems: a hardware architecture based on two processor chips, where each processor may run an independent operating system.
2. MCU: Micro Controller Unit, configured to run a small-core Real-Time Operating System (RTOS), where the chip may have the characteristic of extremely low power consumption.
3. AP: Application Processor, i.e., a processor running an Android system.
4. DSI: Display Serial Interface, a control interface of a display module.
5. DDIC: Display Driver Integrated Circuit, i.e., a driver chip inside a screen.
6. MIPI: Mobile Industry Processor Interface.

Technical solutions in some embodiments of the present disclosure will be described below with reference to the accompanying drawings.

To clearly describe the technical solutions in the embodiments of the present disclosure, terms such as “first” and “second” are used in the embodiments of the present disclosure to distinguish the same or similar items with basically the same functions and effects. For example, a first input interface and a second input interface are configured to distinguish different input interfaces, and their sequence is not limited. Those skilled in the art may understand that terms such as “first” and “second” do not limit the quantity and execution order, and terms such as “first” and “second” do not necessarily indicate that they are different.

It should be noted that in the present disclosure, words such as “exemplarily” or “for example” are configured to represent examples, illustrations, or explanations. Any embodiment or design solution described as “exemplarily” or “for example” in the present disclosure should not be interpreted as being more preferred or having more advantages than other embodiments or design solutions. Specifically, the use of words such as “exemplarily” or “for example” is intended to present related concepts in a specific manner.

In addition, “at least one” means one or more, and “a plurality of” means two or more. The term “and/or” describes the association relationship of associated objects and indicates that there may be three relationships. For example, A and/or B may indicate: A exists alone, A and B exist simultaneously, and B exists alone, where A and B may be singular or plural. The character “/” generally indicates that the associated objects are in an “or” relationship. The expression “at least one of the following” or similar expressions refers to any combination of these items, including any combination of a single item (piece) or a plurality of items (pieces). For example, at least one (piece) of a, b, and c may indicate: a, b, c, a and b, a and c, b and c, or a, b, and c, where a, b, and c may be singular or plural.

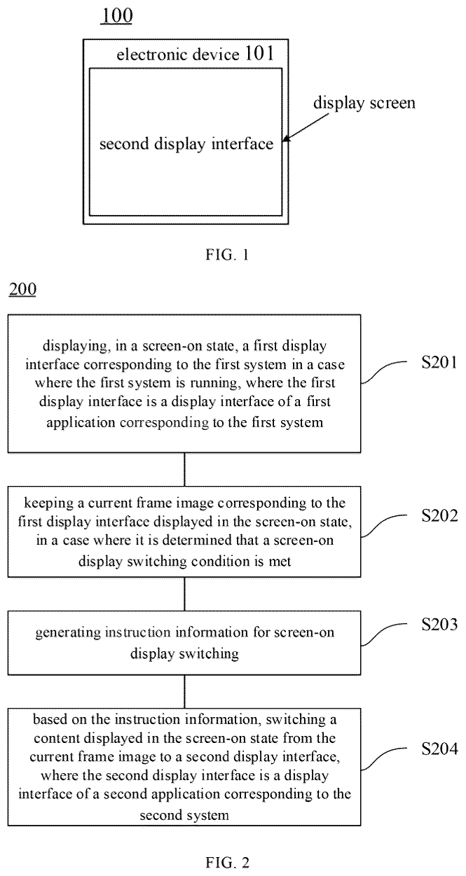

FIG. 1 shows an application scenario 100 according to some embodiments of the present disclosure. As shown in FIG. 1, the application scenario 100 may include an electronic device 101. The electronic device 101 may support running of a first system and a second system. The electronic device 101 may assign a scenario with complex operation logic and gorgeous interface to a large-core system for processing, and a scenario with relatively simple and single functions to a small-core system for processing. Two systems may cooperate with each other and switch intelligently, so as to achieve a goal of long battery life of a smart watch. As shown in FIG. 1, the electronic device 101 may include a display screen. A second display interface of a second application corresponding to the second system may be currently displayed on a display screen in a screen-on state.

It should be understood that before displaying the second display interface, the electronic device 101 may display a first display interface. The first display interface may be a display interface of a first application corresponding to the first system. When it is determined that a screen-on display switching condition is met, the electronic device 101 may switch the first display interface displayed in a screen-on state to the currently displayed second display interface, so as to implement screen-on display switching.

However, during a process of implementing the above-mentioned screen-on display switching, the electronic device 101 needs to perform a screen-off operation, which may cause a phenomenon with a black image on the screen, and the phenomenon may be easily perceived by the user, resulting in a poor user experience.

In view of this, some embodiments of the present disclosure may provide a display switching method and an electronic device. When it is determined that screen-on display switching is met/satisfied, the electronic device may keep a current frame image of a current display interface (i.e., a first display interface) displayed in the screen-on state. When display data corresponding to a second system is detected, the electronic device may display a second display interface corresponding to the second system. That is, the electronic device may switch a content displayed in the screen-on state from the current frame image of the first display interface to the second display interface, such that it may be possible to implement screen-on display switching under dual systems. In other words, in some embodiments of the present disclosure, it may be possible to keep the current frame image of the first display interface displayed in the screen-on state before display switching, such that it may be possible to enable the electronic device to implement display switching without performing the screen-off operation, i.e., without turning off the screen, thereby improving the user experience.

In order make the objectives, technical solutions of the present disclosure clearer and more intuitive, the display switching method and the electronic device provided by the embodiments of the present disclosure will be described in detail below with reference to the accompanying drawings and embodiments. It should be understood that some specific embodiments described herein are only used to explain the present disclosure, and are not used to limit the present disclosure.

FIG. 2 is a schematic flowchart of a display switching method 200 according to some embodiments of the present disclosure. The method 200 may be applicable to the above-mentioned application scenario 100 shown in FIG. 1. The method 200 may also be applicable to other scenarios, which is not limited herein. As shown in FIG. 2, the method 200 may include the following operations.

In an operation S201, when the first system is running, the electronic device may display, in a screen-on state, a first display interface corresponding to the first system. The first display interface may be a display interface of a first application corresponding to the first system.

In an operation S202, when it is determined that a screen-on display switching condition is met, the electronic device may keep a current frame image corresponding to the first display interface displayed in the screen-on state.

It should be understood that before displaying the current frame image of the first interface, the electronic device may also stop refreshing the first display interface displayed in the screen-on state, and determine the current frame image corresponding to the first display interface. When a display holding instruction is detected, the electronic device may keep the current frame image corresponding to the first display interface displayed in the screen-on state until the electronic device displays, in the screen-on state, the second display interface corresponding to the second system.

It should also be understood that the above-mentioned screen-on display switching condition may include that current power consumption of the electronic device may meet a power consumption threshold, an application corresponding to the second system may be detected to run, or a preset user operation may be detected, etc., which is not limited herein.

In a possible embodiment, operating power consumption of the first system may be greater than that of the second system. When it is determined that the current power consumption of the electronic device is less than a first power consumption threshold among power consumption thresholds, it is determined that the screen-on display switching condition is met. The first power consumption threshold may be configured to indicate the minimum power consumption for running the first system.

In another possible embodiment, the operating power consumption of the first system may be less than that of the second system. When it is determined that the current power consumption of the electronic device is greater than or equal to a second power consumption threshold among power consumption thresholds, it is determined that the screen-on display switching condition is met. The second power consumption threshold may be configured to indicate the minimum power consumption for running the second system.

In an operation S203, the electronic device may generate instruction information for screen-on display switching.

In a possible embodiment, the instruction information for screen-on display switching may be a preset level signal. The instruction information for screen-on display switching may be configured to instruct the electronic device to display, in the screen-on state, an image of a system corresponding to a non-preset level signal.

In some embodiments, the preset level signal may be a second level signal. When it is determined that the level signal of the first system is currently the second level signal, the electronic device may switch a display authority from the first system to the second system, and display, in the screen-on state, the second display interface corresponding to the second system, such that it may be possible to switch the content displayed in the screen-on state from the current frame image to the second display interface. The preset level signal may also be called a low-level signal.

In another possible embodiment, the instruction information for screen-on display switching may be interface information. the instruction information for screen-on display switching may be configured to instruct the electronic device to display, in the screen-on state, an image of a system corresponding to non-interface information,

In some embodiments, when first interface information corresponding to the first system is obtained, the electronic device may switch the display authority from the first system to the second system. The second system may correspond to a second interface, and the first interface may be different from the second interface. The electronic device may display, in the screen-on state, the second display interface corresponding to the second system, such that it may be possible to switch the content displayed in the screen-on state from the current frame image to the second display interface.

In an operation S204, the electronic device may switch the content displayed in the screen-on state from the current frame image to a second display interface based on the instruction information. The second display interface may be a display interface of a second application corresponding to the second system.

It should be understood that the first application mentioned above may be the same or different.

In some embodiments, when the operating power consumption of the first system is less than that of the second system, the applications corresponding to the second system may include the first application corresponding to the first system, and the first application and the second application may be a same application, that is, the second display interface and the first display interface may be display interfaces of the same application. In some embodiments, the second display interface may be a display interface which may be loaded and displayed after the current frame image corresponding to the first display interface. In some embodiments, the first application and the second application may be not the same application, and the second display interface and the first display interface may be not display interfaces of the same application.

In some embodiments, when the operating power consumption of the first system is greater than that of the second system, the application corresponding to the second system may not include the first application corresponding to the first system, and the first application and the second application may be not the same application. That is, the second display interface and the first display interface may be not display interfaces of the same application.

In some embodiments of the present disclosure, when it is determined that screen-on display switching is met, the electronic device may keep the current frame image of the current display interface (i.e., the first display interface) displayed in the screen-on state. When display data corresponding to the second system is detected, the electronic device may display the second display interface corresponding to the second system. That is, the electronic device may switch the content displayed in the screen-on state from the current frame image of the first display interface to the second display interface, such that it may be possible to implement the screen-on display switching under the dual systems. In other words, in some embodiments of the present disclosure, it may be possible to keep the current frame image of the first display interface displayed in the screen-on state before display switching, such that it may be possible to enable the electronic device to implement display switching without performing the screen-off operation, i.e., without turning off the screen, thereby improving the user experience.

It should be understood that the electronic device involved in the embodiments of the present disclosure may be a mobile phone, a watch, a notebook computer, a palmtop computer, a mobile internet device (MID), a wearable device, a virtual reality (VR) device, an augmented reality (AR) device, a wireless terminal in industrial control, a wireless terminal in self-driving, a wireless terminal in remote medical surgery, a wireless terminal in a smart grid, a wireless terminal in transportation safety, a wireless terminal in a smart city, a wireless terminal in a smart home, a personal digital assistant (PDA), etc., which is not limited herein.

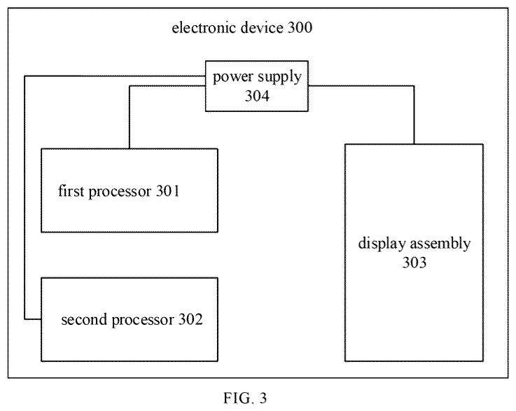

FIG. 3 is a schematic diagram of a system architecture of an electronic device 300 according to some embodiments of the present disclosure. As shown in FIG. 3, the electronic device 300 may include a first processor 301, a second processor 302, a display assembly 303, and a power supply 304. The first processor 301 may be configured to run a first system and send display data corresponding to the first system to the display assembly 303. The second processor 302 may be configured to run a second system (i.e., a dual-core and dual-system) and send display data corresponding to the second system to the display assembly 303. The display assembly 303 may be configured to display the display data corresponding to the first system or the display data corresponding to the second system. The power supply 304 may be configured to provide power for various devices or circuits in the electronic device 300.

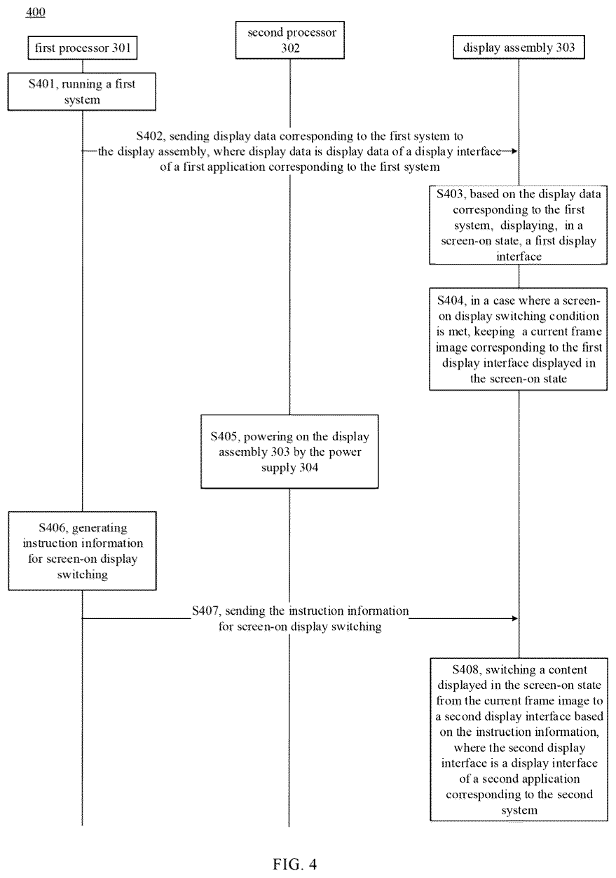

The display switching method provided by some embodiments of the present disclosure will be described in detail below with reference to the electronic device 300 shown in FIG. 3 and FIG. 4.

FIG. 4 is a flowchart of a display switching method 400 according to some embodiments of the present disclosure. As shown in FIG. 4, the method 400 may include the following operations.

In an operation S401, the first processor 301 may run a first system.

In an operation S402, the first processor 301 may send display data corresponding to the first system to the display assembly 303. Correspondingly, the display assembly 303 may receive the display data corresponding to the first system sent from the first processor 301. The display data may be display data of a display interface of a first application corresponding to the first system.

In an operation S403, based on the display data corresponding to the first system, a first display interface may be displayed in a screen-on state by the display assembly 303.

It should be understood that when the display assembly 303 displays the display data corresponding to the first system, it means that a current display authority may be at the first system corresponding to the first processor.

In an operation S404, when a screen-on display switching condition is met, the display assembly 303 may keep a current frame image corresponding to the first display interface displayed in the screen-on state.

It should be understood that the above-mentioned display switching condition may include determining that the current power consumption of the electronic device meets a power consumption threshold, detecting that an application corresponding to the second system runs; or detecting a preset user operation, etc., which is not limited herein.

In an operation S405, the second processor 302 may power on the display assembly 303 by the power supply 304.

In an operation S406, the first processor 301 may generate instruction information for screen-on display switching.

In an operation S407, the first processor 301 may send the instruction information for screen-on display switching to the display assembly 303. Correspondingly, the display assembly 303 may receive the instruction information for screen-on display switching sent from the first processor 301.

In some embodiments, the instruction information for screen-on display switching may be a preset level signal or interface information. When the instruction information for screen-on display switching is a preset level signal, the instruction information may be configured to instruct the display assembly 303 to display, in the screen-on state, an image of a system corresponding to a non-preset level signal. Alternatively, when the instruction information for screen-on display switching is the above-mentioned interface information, the instruction information may be configured to instruct the display assembly 303 to display, in the screen-on state, an image of a system corresponding to non-interface information.

In an operation S408, the display assembly 303 may switch the content displayed in the screen-on state from the current frame image to a second display interface based on the instruction information. The second display interface may be a display interface of a second application corresponding to the second system.

It can be understood that in the embodiment of the present disclosure, the first processor and the second processor may work asynchronously, and the first system and the second system may need to implement system communication (which may also be called dual-core communication).

In a possible scenario, the first system in the above-mentioned electronic device may be an Android operating system running on an application processor (AP, which may also be called a large core). The second system may be a real-time operating system (RTOS) running on a micro controller unit (MCU, which may also be called a small core).

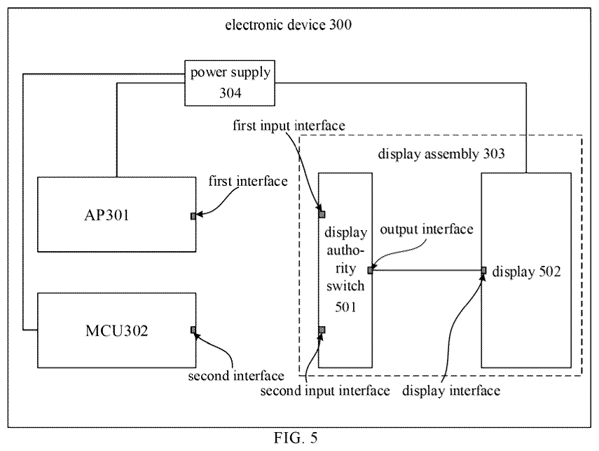

FIG. 5 shows a schematic diagram of the above-mentioned electronic device 300. As shown in FIG. 5, the first processor 301 and the second processor 302 in the electronic device 300 may be an AP and an MCU, respectively. In addition, the display assembly 303 in the electronic device 300 may further include a display authority switch 501 and a display 502. The AP 301 may include a first interface. The first interface may be configured to send display data corresponding to the Android system to the display assembly 303. The MCU 302 may include a second interface. The second interface may be configured to send display data corresponding to the RTOS system to the display assembly 303. The display authority switch 501 in the display assembly 303 may include a first input interface, a second input interface, and an output interface. The first input interface may be configured to receive the display data corresponding to the Android system from the AP 301. The second input interface may be configured to receive the display data corresponding to the RTOS system from the MCU 302. The first input interface and the second input interface of the display authority switch 501 may further be configured to receive level signals from the AP 301 or the MCU 302 to switch the display authority. The output interface may be configured to send the received display data corresponding to the Android system or the display data corresponding to the RTOS system to the display 502. The display 502 may be configured to receive and display the display data corresponding to the Android system or the display data corresponding to the RTOS system by a display interface.

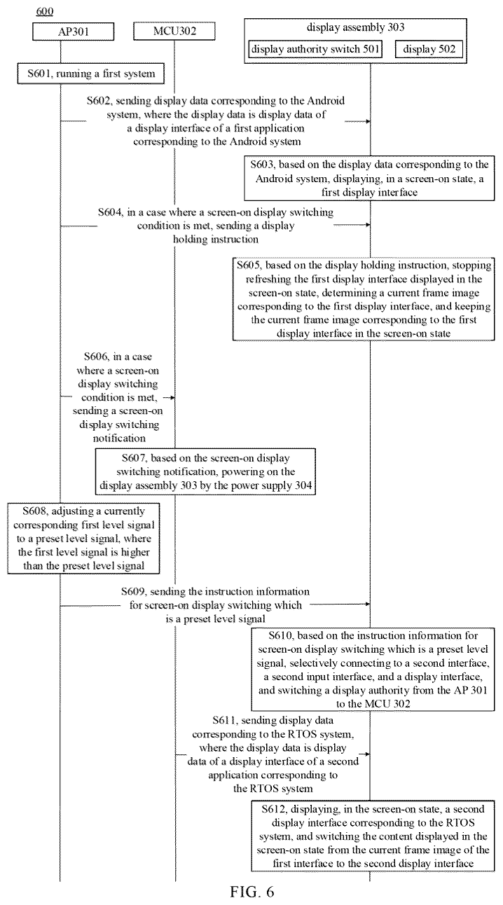

The display switching method provided by some embodiments of the present disclosure will be described in detail below with reference to the electronic device 300 shown in FIG. 5 and FIG. 6.

FIG. 6 is a flowchart of a display switching method 600 according to some embodiments of the present disclosure. As shown in FIG. 6, the method 600 may include the following operations.

In an operation S601, an Android system may be run by the AP 301.

In an operation S602, the AP 301 may send display data corresponding to the Android system to the display assembly 303 by the first interface. Correspondingly, the display assembly 303 may receive the display data corresponding to the Android system sent from the AP 301. The display data may be display data of a display interface of a first application corresponding to the Android system.

In some embodiments, the display assembly 303 may receive the display data corresponding to the Android system sent from the AP 301 by the first input interface of the display authority switch 501, and transmit the display data corresponding to the Android system to the display 502 by the output interface of the display authority switch 501. The display interface of the display 502 and the output interface of the display authority switch 501 may be in a connected state, such that it may be possible to enable the display 502 to receive the display data from the AP 301.

It should be understood that the first interface and the first input interface are currently connected, which may indicate that the current display authority may belong to the Android system corresponding to the AP 301.

In an operation S603, based on the display data corresponding to the Android system, a first display interface may be displayed in a screen-on state by the display assembly 303.

In an operation S604, when a screen-on display switching condition is met, the AP 301 may send a display holding instruction to the display assembly 303 by the first interface. Correspondingly, the display assembly 303 may receive the display holding instruction from the AP 301.

In some embodiments, the display assembly 303 may receive the display holding instruction from the AP 301 by the first input interface of the display authority switch 501, and transmit the display holding instruction to the display 502 by the output interface of the display authority switch 501. The display interface of the display 502 and the output interface of the display authority switch 501 may be in a connected state, such that it may be possible to enable the display 502 to receive the display holding instruction from the AP 301.

In some embodiments, when it is detected that a second application corresponding to the second system (i.e., the RTOS system) is started, the AP 301 may determine that the display switching condition is met.

In some embodiments, when a preset user operation, such as multi-finger sliding/swiping on the display screen, is detected, the AP 301 may determine that the display switching condition is met.

In an operation S605, based on the display holding instruction, the display assembly 303 may stop refreshing the first display interface displayed in the screen-on state, determine a current frame image corresponding to the first display interface, and keep the current frame image corresponding to the first display interface displayed in the screen-on state.

In some embodiments, the display assembly 303 may stop refreshing the first display interface displayed in the screen-on state by the display 502, and keep the current frame image corresponding to the first display interface displayed in the screen-on state.

In an operation S606, when a screen-on display switching condition is met, the AP 301 may send a screen-on display switching notification to the MCU 302. Correspondingly, the MCU 302 may receive the screen-on display switching notification from the AP 301.

In a possible embodiment, the AP 301 may send the screen-on display switching notification to the MCU 302 through a dual-core communication technology. Correspondingly, the MCU 302 may further receive the screen-on display switching notification from the AP 301 through dual-core communication.

It should be understood that the above embodiments merely take an example of sending the display holding instruction first (such as the operation S604 as described above) and then sending the screen-on display switching notification (such as the operation S606 as described above). In addition to this, when the screen-on display switching condition is met, the AP 301 may also first perform an operation of sending the screen-on display switching notification to the MCU 302, and then perform an operation of sending the display holding instruction, which is not limited herein.

It should also be understood that in addition to the above-mentioned sending of the screen-on display switching notification by the AP 301 when the screen-on display switching condition is met, the AP 301 may also send the screen-on display switching notification to the MCU 302 after determining to send the above-mentioned display holding instruction. Correspondingly, when the AP 301 sends the screen-on display switching notification first and then sends the display holding instruction, the display holding instruction may also be understood as being triggered and sent by the AP 301 after determining to send the above-mentioned screen-on display switching notification, which is not limited herein.

In an operation S607, based on the screen-on display switching notification, the MCU 302 may power on the display assembly 303 by the power supply 304.

In an operation S608, the AP 301 may adjust a currently corresponding first level signal to a preset level signal. The first level signal may be higher than the preset level signal.

It should be understood that the above-mentioned first level signal may also be called a high-level signal, and the preset level signal may also be called a low-level signal. When it is determined that the level signal of the AP 301 is the high-level signal, it may be determined that the current display authority may belong to the Android system corresponding to the AP 301. In other words, when the display assembly 303 receives the instruction information for screen-on display switching which is a preset level signal, a display switching operation may be performed, such that the display authority does not belong to the system corresponding to the preset level signal.

In some embodiments, the above-mentioned first level signal and second level signal may be chip select (CS) signals.

In an operation S609, the AP 301 may send the instruction information for screen-on display switching which is a preset level signal to the display assembly 303. Correspondingly, the display assembly 303 may receive the preset level signal from the AP 301.

In some embodiments, the display assembly 303 may receive the preset level signal from the AP 301 by the display authority switch 501.

It should be understood that in addition to the first input interface and the second input interface shown in FIG. 5 described above, the display authority switch 501 may further include general purpose IO (GPIO) ports. In addition to the first interface shown in FIG. 5 described above, the AP 301 may further include a GPIO interface. The GPIO interface of the display authority switch 501 may correspond to the GPIO interface of the AP 301 and may be in a normally connected state, that is, the AP 301 may send the above-mentioned level signal to the display assembly 303 by the GPIO interface. Correspondingly, the display assembly 303 may receive the level signal from the AP 301 by the GPIO interface of the display authority switch 501.

It should also be understood that the instruction information for screen-on display switching which is a preset level signal may be sent after the AP 301 sends the above-mentioned display holding instruction and the screen-on display switching notification, such that the MCU 302 may make preparation for display switching in advance, and successfully switch the display authority to the MCU 302 when the display 502 in the display assembly 303 does not have a black image on the screen (or does not turn back).

In an operation S610, based on the instruction information for screen-on display switching which is a preset level signal, the display assembly 303 may be selectively connected to the second interface, the second input interface, and the display interface, such that it may be possible to switch the display authority from the AP 301 to the MCU 302.

In some embodiments, based on the instruction information for screen-on display switching which is a preset level signal, the display assembly 303 may be selectively connected to the second interface, the second input interface, and the display interface by the display authority switch 501, such that it may be possible to switch the display authority from the AP 301 to the MCU 302.

In an operation S611, the MCU 302 may send display data corresponding to the RTOS system to the display assembly 303 by the second interface. The display data may be display data of a display interface of a second application corresponding to the RTOS system. Correspondingly, the display assembly 303 may receive the display data from the MCU 302.

In some embodiments, the display assembly 303 may receive the display data from the MCU 302 by the second input interface of the display authority switch 501, and transmit the display data to the display 502 by the output interface of the display authority switch 501. The display interface of the display 502 and the output interface of the display authority switch 501 may be in a connected state, such that the display 502 may receive the display data from the MCU 302.

In an operation S612, the display assembly 303 may display, in the screen-on state, a second display interface corresponding to the RTOS system, such that it may be possible to switch the content displayed in the screen-on state from the current frame image of the first interface to the second display interface.

In some embodiments, the display assembly 303 may display, in the screen-on state, the second display interface corresponding to the above-mentioned RTOS system by the display 502.

In some embodiments, the MCU 302 may further notify the AP 301 to power off the display 502 and enter a sleep state, such that power consumption may be reduced.

In some embodiments, when the Android system corresponding to the AP 301 has a level signal, after the operation S612 described above, when the MCU 302 determines that the current display switching condition is met, the MCU 302 may enable the AP 301 to adjust its current preset level signal to the above-mentioned first level signal by the screen-on display switching notification, such that the display assembly 303 switches the display authority back to the Android system corresponding to the AP 301 (i.e., the system corresponding to the first level signal) based on the instruction information for screen-on display switching which is the first level signal.

It should be understood that the above-mentioned embodiment mainly describes the display switching method provided by some embodiments of the present disclosure by taking an example that the first system (such as the Android system corresponding to the AP 301) may have a corresponding level signal. In addition to this, in some embodiments of the present disclosure, the display switching method may further be implemented when the second system (such as the RTOS system corresponding to the MCU 302 described above) has a corresponding level signal, which is not limited herein.

In some embodiments, when the RTOS system corresponding to the MCU 302 has a level signal, in a case where the MCU 302 determines that the current display switching condition is met, the MCU 302 may actively send the instruction information for screen-on display switching which is a preset level signal to the display assembly 303, such that the display assembly 303 may switch the display authority to the Android system corresponding to the AP 301, i.e., a system other than the system corresponding to the preset level signal. Alternatively, based on the display switching notification from the AP 301, the MCU 302 may also send the instruction information for screen-on display switching which is the first level signal to the display assembly 303, such that the display assembly 303 may switch the display authority to the system corresponding to the first level signal, i.e., the above-mentioned RTOS system.

It should be understood that the first system may be capable of processing an event processed by the second system, while the second system may not be able to process the event processed by the first system. That is, a performance of the first processor is higher than a performance of the second processor. In other words, the application corresponding to the second system may not include the above-mentioned first application corresponding to the first system, that is, the above-mentioned second display interface and the first display interface may be not display interfaces of the same application.

In some embodiments, when displaying a display interface of a first application (such as a video application), in a case where the electronic device detects an instruction to start a second application, such as a short message application, and determines that the short message application is an application corresponding to the second processor, the electronic device may run the short message application and switch the display authority to the second system to display the display interface of the short message application.

In some embodiments, in some embodiments of the present disclosure, an application corresponding to both the first system and the second system may also be set. When the electronic device displays, in the screen-on stare, the display interface of the application, in a case where it is determined that the current power consumption is less than a first power consumption threshold among the power consumption thresholds, it may be indicated that the display switching condition is met, and the display authority may be switched from the first system to the second system. That is, the second system may continue to display the display interface of the application. The first power consumption threshold may be configured to indicate the minimum power consumption for running the first system.

In some embodiments, the applications corresponding to both the first system and the second system may include a short message application. When the electronic device displays the display interface of the short message application, in a case where it is determined that the current power consumption is less than a first power consumption threshold among the power consumption thresholds, the electronic device may switch the display authority from the above-mentioned first system to the second system. That is, the electronic device may switch from the first processor running and displaying the short message application to the second processor running and displaying the short message application.

In another possible scenario, the second system in the above-mentioned electronic device may also be an Android operating system running on an application processor (AP), and the first system may be a real-time operating system (RTOS) running on a micro controller unit (MCU).

It can be understood that the second system may be capable of processing an event processed by the first system, while the first system may not be able to process the event processed by the second system. That is, a performance of the second processor is higher than a performance of the first processor.

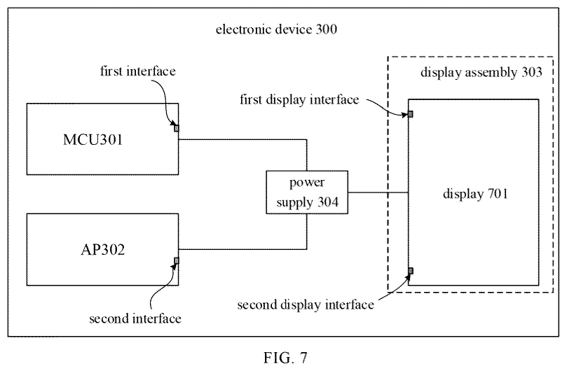

FIG. 7 shows a schematic diagram of the above-mentioned electronic device 300. As shown in FIG. 7, the first processor 301 and the second processor 302 included in the electronic device 300 may be an MCU and an AP, respectively. In addition, the display assembly 303 in the electronic device 300 may further include a display 701. The MCU 301 may include a first interface, and the first interface may be configured to send display data corresponding to the RTOS to the display assembly 303. The AP 302 may include a second interface, and the second interface may be configured to send display data corresponding to the Android system to the display assembly 303. The display 701 in the display assembly 303 may include a first display interface and a second display interface. The first display interface may be configured to receive the display data corresponding to the RTOS system from the MCU 301 and display the display data. The second display interface may be configured to receive the display data corresponding to the Android system from the AP 302 and display the display data. The first display interface and the second display interface of the display 701 may also be respectively configured to receive interface information from the MCU 301 or the AP 302 to switch the display authority.

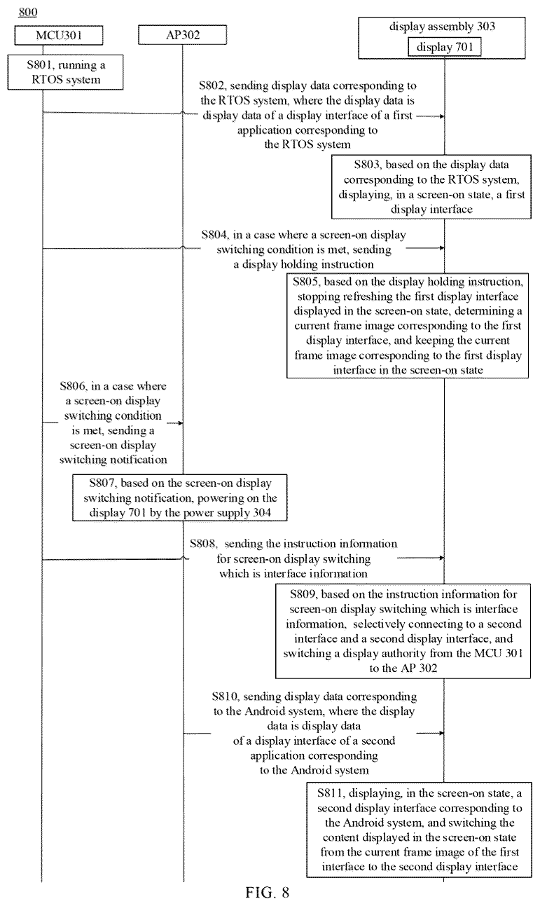

The display switching method provided by some embodiments of the present disclosure will be described in detail below with reference to the electronic device 300 shown in FIG. 7 and FIG. 8.

FIG. 8 is a flowchart of a display switching method 800 according to some embodiments of the present disclosure. As shown in FIG. 8, the method 800 may include the following operations.

In an operation S801, an RTOS system may be run by the MCU 301.

In an operation S802, the MCU 301 may send display data corresponding to the RTOS system to the display 701. Correspondingly, the display 701 may receive the display data corresponding to the RTOS system sent from the MCU 301. The display data may be display data of a display interface of a first application corresponding to the RTOS system.

In an operation S803, based on the display data corresponding to the RTOS system, a first display interface may be displayed in the screen-on state by the display 701.

It should be understood that the display 701 currently displays the display data corresponding to the RTOS system, which may indicate that the current display authority may belong to the RTOS system.

In an operation S804, when a screen-on display switching condition is met, the MCU 301 may send a display holding instruction to the display 701 by the first interface. Correspondingly, the display 701 may receive the display holding instruction from the MCU 301 by the first display interface.

It should be understood that when it is detected that a second application corresponding to the second system, i.e., the Android system, is started, the AP 301 may determine that the display switching condition is met. Alternatively, when a preset user operation, such as multi-finger sliding on the display screen, is detected, the AP 301 may determine that the display switching condition is met.

In an operation S805, based on the display holding instruction, the display 701 may stop refreshing the first display interface displayed in the screen-on state, determine a current frame image corresponding to the first display interface, and keep the current frame image corresponding to the first display interface displayed in the screen-on state.

It should be understood that the display 701 may need to keep the current frame image of the first interface displayed in the screen-on state until the display authority is controlled by the Android system and the display data corresponding to the Android system is received.

In an operation S806, when a screen-on display switching condition is met, the MCU 301 may send a screen-on display switching notification to the AP 302. Correspondingly, the AP 302 may receive the screen-on display switching notification from the MCU 301.

In a possible embodiment, the MCU 301 may send the screen-on display switching notification to the AP 302 through a dual-core communication technology. Correspondingly, the AP 302 may further receive the screen-on display switching notification from the MCU 301 through the dual-core communication.

It should be understood that the above embodiments merely take an example of sending the display holding instruction first (such as the operation S804 described above) and then sending the screen-on display switching notification ((such as the operation S806 described above). In addition to this, when the screen-on display switching condition is met, the MCU 301 may also first perform an operation of sending the screen-on display switching notification to the AP 302, and then perform an operation of sending the display holding instruction, which is not limited herein.

It should also be understood that in addition to the above-mentioned sending of the screen-on display switching notification by the MCU 301 when the screen-on display switching condition is met, the MCU 301 may also send the screen-on display switching notification to the AP 302 after determining to send the above-mentioned display holding instruction. Correspondingly, when the MCU 301 sends the screen-on display switching notification first and then sends the display holding instruction, the display holding instruction may also be triggered and sent by the MCU 301 after determining to send the above-mentioned screen-on display switching notification, which is not limited herein.

In an operation S807, based on the screen-on display switching notification, the AP 302 may power on the display 701 by the power supply 304.

In an operation S808, the MCU 301 may send the instruction information for screen-on display switching which is interface information to the display 701 by the first interface. Correspondingly, the display 701 may receive the instruction information for screen-on display switching which is interface information from the MCU 301 by the first display interface.

In some embodiments, the above-mentioned interface information may be first interface information of the MCU 301, i.e., interface information corresponding to the system where the display authority is currently located.

It should be understood that the instruction information for screen-on display switching which is interface information may be sent after the MCU 301 sends the above-mentioned display holding instruction and the screen-on display switching notification, such that the AP 302 may make preparation for display switching in advance, and successfully switch the display authority to the AP 302 when the display 701 does not have a black image on the screen.

In an operation S809, based on the instruction information for screen-on display switching which is interface information, the display 701 may be selectively connected to the second interface and the second display interface, such that it may be possible to switch the display authority from the MCU 301 to the AP 302.

In some embodiments, the display 701 may be selectively connected to the second interface and the second display interface by a DDIC, such that it may be possible to switch the display authority from the MCU 301 to the AP 302. The DDIC may support the above-mentioned first display interface or the above-mentioned second display interface.

It should be understood that when the display 701 may receive the interface information, a currently selectively connected interface (i.e., the above-mentioned first interface) may be closed, and another interface (i.e., the second interface) may be selectively connected, such that it may be possible to switch the display authority.

In an operation S810, the AP 302 may send display data corresponding to the Android system to the display 701 by the second interface. The display data may be display data of a display interface of a second application corresponding to the Android system. Correspondingly, the display 701 may receive the display data from the AP 302 by the second display interface.

In an operation S811, the display 701 may display, in the screen-on state, a second display interface corresponding to the Android system, such that it may be possible to switch the content displayed in the screen-on state from the current frame image of the first interface to the second display interface.

In some embodiments, the AP 302 may further notify the MCU 301 to power off the display 701, so as to reduce power consumption.

It should be understood that the second system may be capable of processing an event processed by the first system, while the first system may not be able to process the event processed by the second system. That is, a performance of the second processor is higher than a performance of the first processor. In other words, the applications corresponding to the second system may include the above-mentioned first application corresponding to the first system,

In a possible embodiment, the above-mentioned first application and the second application may be not the same application, that is, the second display interface and the first display interface may be not display interfaces of the same application.

In another possible embodiment, the above-mentioned first application and the second application may be the same application. That is, the second display interface and the first display interface may be display interfaces of the same application, and the second display interface may be a display interface which may be loaded and displayed after the current frame image corresponding to the first display interface.

In some embodiments, when it is determined that the current power consumption is less than a second power consumption threshold among the power consumption thresholds, it may be indicated that the display switching condition is met, and the electronic device may switch the display authority from the first system to the second system. That is, the second system may continue to display the display interface of the application. The second power consumption threshold may be configured to indicate the minimum power consumption for running the second system.

It should be understood that the processor in the electronic device 300 may include, in addition to the AP and MCU shown above, a graphics processing unit (GPU), an image signal processor (ISP), a controller, a video codec, a digital signal processor (DSP), a baseband processor, and/or a neural-network processing unit (NPU), etc. Different processing units may be independent devices, or may be integrated into one or more processors. The above-mentioned display may adopt a liquid crystal display (LCD), an organic light-emitting diode (OLED), an active-matrix organic light-emitting diode (AMOLED), a flexible light-emitting diode (FLED), Miniled, MicroLed, Micro-oLed, a quantum dot light emitting diode (QLED), etc. The MIPI interface may be configured to connect the above-mentioned processor and the display assembly. The MIPI interface may include a camera serial interface (CSI), a display serial interface (DSI), etc. In the embodiment of the present disclosure, the above-mentioned processor and the display assembly may communicate with each other by a DSI interface (i.e., the above-mentioned first interface, the above-mentioned second interface, the above-mentioned display interface, the above-mentioned first display interface, and the above-mentioned second display interface), so as to implement the display function of the electronic device 300.

In addition, in some embodiments, the above-mentioned processor may further include other interfaces. The interfaces may include an inter-integrated circuit (I2C) interface, an inter-integrated circuit sound (I2S) interface, a pulse code modulation (PCM) interface, a universal asynchronous receiver/transmitter (UART) interface, a general-purpose input/output (GPIO) interface, a subscriber identity module (SIM) interface, and/or a universal serial bus (USB) interface, etc.

In some embodiments, the electronic device 300 may further include a memory and a transceiver. The above-mentioned first processor, the above-mentioned second processor, the above-mentioned transceiver, and the above-mentioned memory may communicate with each other by internal connection paths to transmit display data, etc. The memory may be configured to store a computer program. The above-mentioned processor may call and run the computer program from the memory.

The above-mentioned first processor or the above-mentioned second processor may be combined with the memory to form a processing device. More commonly, the first processor/the second processor and the memory may be independent components. The above-mentioned processor may be configured to execute a program code stored in the memory to implement the above-mentioned functions. During specific implementation, the memory may also be integrated into the above-mentioned processor, or be independent of the above-mentioned processor.

The transceiver may provide a wireless communication solution applied to the electronic device 300, including a wireless local area network (WLAN) (such as a wireless fidelity (Wi-Fi) network), Bluetooth (BT), a global navigation satellite system (GNSS), frequency modulation (FM), near field communication (NFC), infrared (IR) technology, etc. The transceiver may be one or more devices integrating at least one communication processing module.

In addition, in order to make the functions of the electronic device 300 more complete, the electronic device 300 may further include one or more of an input unit, an audio circuit, a sensor, etc., which is not limited herein.

It can be understood that the schematic diagram of the interface connection relationship among the modules shown in the embodiment of the present disclosure is only a schematic description, and does not constitute a structural limitation on the electronic device.

In other embodiments of the present disclosure, the electronic device may also be provided with a single processor, and the first system and the second system may run on different cores of the processor respectively, where the processing performance of the core running the first system is higher than that of the core running the second system, which is not limited herein.

It should also be understood that the Android system and RTOS system shown above are only exemplary, and the present disclosure is not limited thereto.

It should be understood that the above-mentioned various embodiments may also be coupled with each other, which is not limited herein. The sequence numbers of the above-mentioned processes do not mean the execution sequence, and the execution sequence of each process should be determined by its functions and internal logic, and should not constitute any limitation on the implementation process of the embodiments of the present disclosure.

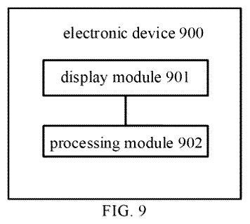

FIG. 9 shows another electronic device 900 according to some embodiments of the present disclosure. The electronic device 900 may include a display module 901 and a processing module 902.

The display module 901 may be configured to display, in a screen-on state, a first display interface corresponding to a first system in a case where the first system is running, and keep a current frame image corresponding to the first display interface displayed in the screen-on state in a case where it is determined that a screen-on display switching condition is met, where the first display interface is a display interface of a first application corresponding to the first system. The processing module 901 may be configured to generate instruction information for screen-on display switching. The processing module 902 may be configured to switch a content displayed in the screen-on state from the current frame image to a second display interface based on the instruction information, and the second display interface may be a display interface of a second application corresponding to the second system.

It should be understood that the electronic device 900 here may be embodied in the form of functional modules. A term “module” herein may be referred to an application specific integrated circuit (ASIC), an electronic circuit, a processor (such as a shared processor, a dedicated processor, or a group of processors) and a memory for executing one or more software or firmware programs, a combination of logic circuits, and/or other appropriate components that support the described functions. In an optional example, those skilled in the art may understand that the electronic device 900 may be specifically the electronic device in the above-mentioned embodiment, or the functions of the electronic device in the above-mentioned embodiment may be integrated into the electronic device 900, and the electronic device 900 may be configured to execute each process and/or operation corresponding to the electronic device in the above-mentioned method embodiment. To avoid repetition, details are not described herein again.

The above-mentioned electronic device 900 has the function of implementing the corresponding operations executed by the electronic device in the above-mentioned method; the above-mentioned function may be implemented by hardware, or by hardware executing corresponding software. The hardware or software may include one or more modules corresponding to the above-mentioned function.

Those of ordinary skill in the art may implement that the units and algorithm operations of each example described in combination with the embodiments disclosed herein may be implemented by electronic hardware, or a combination of computer software and electronic hardware. Whether these functions are executed by hardware or software depends on the specific application and design constraints of the technical solution. Professionals may use different methods to implement the described functions for each specific application, but such implementation should not be considered to be beyond the scope of the present disclosure.

Those skilled in the art may clearly understand that for the convenience and conciseness of description, the specific working processes of the above-described systems, devices, and units may refer to the corresponding processes in the foregoing method embodiments, and details are not described herein again.

In several embodiments provided in the present disclosure, it should be understood that the disclosed systems, devices, and methods may be implemented in other ways. For example, the device embodiments described above are only illustrative. For example, the division of the units is only a logical function division. In actual implementation, there may be other division methods. For example, multiple units or components may be combined or integrated into another system, or some features may be ignored or not executed. In addition, the displayed or discussed mutual coupling or direct coupling or communication connection may be indirect coupling or communication connection through some interfaces, devices, or units, and may be electrical, mechanical, or in other forms.

The units described as separate components may or may not be physically separated, and the components displayed as units may or may not be physical units, that is, may be located in one place, or may be distributed on multiple network units. Some or all of the units may be selected according to actual needs to achieve the objectives of the solutions of the embodiments.

In addition, each functional unit in each embodiment of the present disclosure may be integrated into one processing unit, or each unit may exist alone physically, or two or more units may be integrated into one unit.

In a case where the function is implemented in the form of a software functional unit and sold or used as an independent product, it may be stored in a computer-readable storage medium. Based on such an understanding, the essence of the technical solution of the present disclosure or the part that contributes to the prior art or the part of the technical solution may be embodied in the form of a software product. The computer software product is stored in a storage medium and may include several instructions for enabling a computer device (which may be a personal computer, a server, or a network device, etc.) to execute all or part of the operations of the method described in each embodiment of the present disclosure. The foregoing storage medium may include: a USB flash drive, a removable hard disk, a read-only memory (ROM), a random access memory (RAM), a magnetic disk, or an optical disc and other media that can store program codes.

The above descriptions are only specific embodiments of the present disclosure, but the protection scope of the present disclosure is not limited thereto. Any person skilled in the art can easily think of changes or replacements within the technical scope disclosed in the present disclosure, which should be covered in the protection scope of the present disclosure. Therefore, the protection scope of the present disclosure should be subject to the protection scope of the claims.

1. A display switching method, performed by an electronic device, the electronic device supporting running of a first system and a second system, and the method comprising:
displaying, in a screen-on state, a first display interface corresponding to the first system in a case where the first system is running, wherein the first display interface is a display interface of a first application corresponding to the first system;
keeping a current frame image corresponding to the first display interface displayed in the screen-on state, in a case where it is determined that a screen-on display switching condition is met;
generating instruction information for screen-on display switching; and
based on the instruction information, switching a content displayed in the screen-on state from the current frame image to a second display interface, wherein the second display interface is a display interface of a second application corresponding to the second system.

2. The method according to claim 1, wherein the electronic device comprises a display assembly, the instruction information for screen-on display switching is a preset level signal; and
switching the content displayed in the screen-on state from the current frame image to the second display interface corresponding to the second system, comprises:
switching, by the display assembly, a display authority from the first system to the second system in a case where the first system is corresponding to the preset level signal; and
switching the content displayed in the screen-on state from the current frame image to the second display interface by displaying, by the display assembly, the second display interface corresponding to the second system in the screen-on state.

3. The method according to claim 2, wherein the electronic device further comprises a first processor and a second processor, the first processor corresponds to the first system, the second processor corresponds to the second system, and the display assembly comprises a display authority switch and a display; and
switching, by the display assembly, the display authority from the first system to the second system in a case where the first system is corresponding to the preset level signal, comprises:
receiving, by the display authority switch, the preset level signal corresponding to the first system from the first processor; and
switching, by the display authority switch, the display authority from the first system corresponding to the first processor to the second system corresponding to the second processor based on the preset level signal.

4. The method according to claim 3, wherein the display authority switch comprises a first input interface and a second input interface; and
switching, by the display authority switch, the display authority from the first system corresponding to the first processor to the second system corresponding to the second processor based on the preset level signal, comprises:
switching the display authority from the first system corresponding to the first processor to the second system corresponding to the second processor by switching, by the display authority switch, the display authority from the first input interface to the second input interface based on the preset level signal;
wherein the first input interface is configured to receive data corresponding to the first system from the first processor, and the second input interface is configured to receive data corresponding to the second system from the second processor.

5. The method according to claim 1, wherein the electronic device comprises a display assembly, and the instruction information for screen-on display switching is interface information; and
switching the content displayed in the screen-on state from the current frame image to the second display interface corresponding to the second system comprises:
switching, by the display assembly, the display authority from the first system to the second system in a case where the interface information is first interface information corresponding to the first system, wherein the second system corresponds to a second interface, and the first interface is different from the second interface;
switching the content displayed in the screen-on state from the current frame image to the second display interface by displaying, by the display assembly, the second display interface corresponding to the second system in the screen-on state.

6. The method according to claim 5, wherein the electronic device further comprises a first processor and a second processor, the first processor corresponds to the first system, the second processor corresponds to the second system, the display assembly comprises a display, and the display comprises a first display interface and a second display interface; and
switching, by the display assembly, the display authority from the first system to the second system based on the first interface information corresponding to the first system, comprises:
receiving, by the first display interface of the display, the first interface information corresponding to the first system from the first processor;
switching the display authority from the first system corresponding to the first processor to the second system corresponding to the second processor by switching, by the display, the display authority from the first display interface to the second display interface based on the first interface information;
wherein the first display interface is configured to be selectively connected to the first interface corresponding to the first processor, to enable the display to receive data corresponding to the first system from the first processor, and the second display interface is configured to be selectively connected to the second interface corresponding to the second processor, to enable the display to receive data corresponding to the second system from the second processor.

7. The method according to claim 1, wherein the electronic device comprises a first processor, a second processor, and a display assembly, the first processor corresponds to the first system, and the second processor corresponds to the second system; and
keeping the current frame image corresponding to the first display interface displayed in the screen-on state, comprises:
receiving, by the display assembly, a display holding instruction sent from the first processor;
stopping, by the display assembly, refreshing the first display interface corresponding to the first system displayed in the screen-on state based on the display holding instruction;
determining, by the display assembly, a current frame image corresponding to the first display interface; and
keeping, by the display assembly, the current frame image corresponding to the first display interface displayed in the screen-on state, until the display assembly displays, in the screen-on state, the second display interface corresponding to the second system.

8. The method according to claim 1, wherein after switching the content displayed in the screen-on state from the current frame image to the second display interface, the method further comprises:
performing, by the first processor, a power-off operation on the display assembly.

9. The method according to claim 8, further comprising:
switching, by the first processor, the first system to run in a background; or
switching, by the first processor, the first system to a sleep mode.

10. The method according to claim 1, wherein the electronic device comprises a first processor, a second processor, and a display assembly; and
before generating the instruction information for screen-on display switching, the method further comprises:
receiving, by the second processor, a screen-on display switching notification from the first processor, and powering on the display assembly based on the screen-on display switching notification;
wherein the screen-on display switching notification is sent by the first processor in a case where the screen-on display switching condition is met.

11. The method according to claim 1, wherein meeting the screen-on display switching condition, comprises:
determining that the screen-on display switching condition is met in a case where it is determined that current power consumption of the electronic device meets a power consumption threshold;
determining that the screen-on display switching condition is met in a case where it is detected that an application corresponding to the second system runs; or
determining that the screen-on display switching condition is met in a case where a preset user operation is detected.

12. The method according to claim 1, further comprising:
in a case where a display interface of an application corresponding to the first system and the second system is displayed in the screen-on state, and it is determined that current power consumption is less than a first power consumption threshold among power consumption thresholds, switching a display authority from the first system to the second system, and enabling the second system to display the display interface of the application.

13. An electronic device, comprising:
a display module, configured to display, in a screen-on state, a first display interface corresponding to a first system in a case where the first system is running, and keep a current frame image corresponding to the first display interface displayed in the screen-on state in a case where it is determined that a screen-on display switching condition is met, wherein the first display interface is a display interface of a first application corresponding to the first system; and
a processing module, configured to generate instruction information for screen-on display switching;
wherein the display module is further configured to switch a content displayed in the screen-on state from the current frame image to a second display interface based on the instruction information, and the second display interface is a display interface of a second application corresponding to a second system.

14. The electronic device according to claim 13, wherein the electronic device comprises a display assembly, and the instruction information for screen-on display switching is a preset level signal;
the processing module is configured to:
switch a display authority from the first system to the second system by the display assembly in a case where the first system is corresponding to the preset level signal; and
the display module is configured to:
switch the content displayed in the screen-on state from the current frame image to the second display interface by displaying, in the screen-on state, the second display interface corresponding to the second system by the display assembly.

15. The electronic device according to claim 14, wherein the electronic device further comprises a first processor and a second processor, the first processor corresponds to the first system, the second processor corresponds to the second system, and the display assembly comprises a display authority switch and a display; and
the processing module is configured to:
receive the preset level signal corresponding to the first system from the first processor by the display authority switch; and
switch the display authority from the first system corresponding to the first processor to the second system corresponding to the second processor by the display authority switch based on the preset level signal.

16. The electronic device according to claim 15, wherein the display authority switch comprises a first input interface and a second input interface, and the processing module is configured to:
switch the display authority from the first system corresponding to the first processor to the second system corresponding to the second processor by switching the display authority from the first input interface to the second input interface by the display authority switch based on the preset level signal;
wherein the first input interface is configured to receive data corresponding to the first system from the first processor, and the second input interface is configured to receive data corresponding to the second system from the second processor.

17. The electronic device according to claim 13, wherein the electronic device comprises a display assembly, and the instruction information for screen-on display switching is interface information;
the processing module is configured to:
switch the display authority from the first system to the second system by the display assembly in a case where the interface information is first interface information corresponding to the first system, wherein the second system corresponds to a second interface, and the first interface is different from the second interface;
the display module is configured to:
switch the content displayed in the screen-on state from the current frame image to the second display interface by displaying, in the screen-on state, the second display interface corresponding to the second system by the display assembly.

18. The electronic device according to claim 17, wherein the electronic device further comprises a first processor and a second processor, the first processor corresponds to the first system, the second processor corresponds to the second system, and the display assembly comprises a display, the display comprises a first display interface and a second display interface;
the processing module is configured to:
receive the first interface information corresponding to the first system from the first processor by the first display interface of the display;
switch the display authority from the first system corresponding to the first processor to the second system corresponding to the second processor by switching the display authority from the first display interface to the second display interface by the display based on the first interface information;
wherein the first display interface is configured to be selectively connected to the first interface corresponding to the first processor, to enable the display to receive data corresponding to the first system from the first processor, and the second display interface is configured to be selectively connected to the second interface corresponding to the second processor, to enable the display to receive data corresponding to the second system from the second processor.

19. The electronic device according to claim 13, wherein the processing module is configured to:
switch a display authority from the first system to the second system, and enable the second system to display a display interface of an application, in a case where the display interface of the application corresponding to the first system and the second system is displayed in the screen-on state, and it is determined that current power consumption is less than a first power consumption threshold among power consumption thresholds.

20. A non-transitory computer-readable storage medium, configured to store a computer program, wherein the computer program comprises an instruction configured to perform:
turning on a screen to display a first display interface corresponding to the first system in a case where a first system is running, wherein the first display interface is a display interface of a first application corresponding to the first system:
keeping the screen on to display a current frame image corresponding to the first display interface in a case where it is determined that a screen-on display switching condition is met:
generating instruction information for screen-on display switching; and
based on the instruction information, switching a content displayed on the screen from the current frame image to a second display interface, wherein the second display interface is a display interface of a second application corresponding to a second system.
